(19) United States
(12) Patent Application Publication
(10) Pub. No.: US 2010/0174697 A1
(43) Pub. Date: Jul. 8, 2010

(54) System and Methods for Automatic and Interactive Communication with Web Pages

(75) Inventor: Adi Mor-Barak, Kfar Saba (IL)

Correspondence Address: SOROKER-AGMON ADVOCATE AND PATENT ATTORNEYS, NOLTON HOUSE, 14 SHENKAR STREET, HERZELIYA PITUACH, 46725, IL

(73) Assignee: BIT TO GO LTD., Ra'anana (IL)

(21) Appl. No.: 12/675,972

(22) PCT Filed: Dec. 11, 2008
(86) PCT No.: PCT/IL2008/001605

§ 371 Date: Mar. 2, 2010

Related U.S. Application Data
(60) Provisional application No. 61/013,317, filed on Dec. 13, 2007.

(51) Int. Cl. G06F 17/30

(52) U.S. Cl. 707/705; 707/E17.107

(57) ABSTRACT

A system and methods for creating a service for real time interaction with one or more Web pages, including retrieving information from a Web page and/or operating one or more Web clips of a Web page, as predefined for the service for utilizing the method of the present invention. A method of the present invention includes predefining tasks and parameters of the service, triggering a request to start the service, performing the predefined tasks of the service, thereby reading data from the Web clip and thereby creating retrieved data, and analyzing the retrieved data thereby creating a data analysis report. Preferably, the method further includes forming a reply message based on the predefined parameters and the analysis of the retrieved data, and sending the reply message to a target as defined in the predefined parameters.

### CROSS REFERENCE TO RELATED APPLICATIONS

This application claims the benefit from U.S. provisional application 61/013,317 filed Dec. 13, 2007, the disclosure of which is included herein by reference.

### FIELD OF THE INVENTION

The present invention relates to methods and systems for automatic and interactive information retrieval from Web pages. More particularly, this invention relates to a system and method for creating a service for real time interaction with one or more Web pages, including retrieving information from a Web page and/or operating one or more Web clips of a Web page, as predefined for the service for utilizing the method of the present invention.

### BACKGROUND AND PRIOR ART

The wide world web (WWW, also referred to herein as “Web”) contains a vast amount of information and the extraction of information or valuable usage has become time consuming. Furthermore, the interaction with Web pages is also a time consuming activity and technologically challenging.

Most of us use computer at the office or at home, while most of the usage involves many types of data analysis and interaction with various fields in a Web page. In many cases, data segments from different locations are needed to be analyzed and operated on in order to perform user specific tasks and/or extract valuable resulting information. In many cases, the data segments vary in time and prior art technological implementation consume a large amount of time and effort to manage and operate the relevant data segments.

Prior art methods for retrieving information from the WWW include using databases for storing and/or querying pre-fetched information, and using search engines and/or programmable set of rules.

US patent application 2008268774, by Stack Andrew William et al., provides a content request, storage, and configuration system is provided which associates pieces of content with one or more keywords, and configures the content for the benefit of a user. Users load content into the system or link content elsewhere to the system, and optionally designate a set of actions to be taken. The system stores data, off line, to the system database, and the user searches the database.

PCT application WO2006053902, by Navarro Michel, provides a method of managing and distributing data between a plurality of users and a plurality of target sites from an interfacing platform, which enables a user to address requests to service provider sites. The method requires cooperation of the Web page owner.

U.S. Pat. No. 6,256,623, given to Jones William, provides a computerized system for and method of accessing information from Web-based search services, using a search engine.

US patent application 2004/0210828, by Amir Langer, provides a Web interaction software which enables a mobile telephone to interact automatically with Web resources, in which the Web interaction system includes a query engine which operates on XML format data, translated from data obtained from a Web site, the query engine parsing the XML into SAX events which are then queried by the query engine.

There is a need and it would be advantageous to have a system and method that enables to create and perform real time services for monitoring, retrieving and operating on data segments in a predefined Web pages.

### DEFINITIONS

The term “Web clip” as used herein refers to information source available on the Web that is an existing Web page or a portion of an existing Web page that may contain plain text, images, hyperlinks and HTML forms. An HTML forms may include all types of inputs such as text fields, buttons, etc.

The term “Web service” as used herein refers to a program of instructions executable by the machine to perform method operations designed to support interoperable Machine to Machine interaction over a network.

The term “Web 2.0 semantic component” as used herein refers to components that can be read and used by software agents.

The term “shared database” as used herein refers to databases that can be queried.

The term “data segment” as used herein refers to segments of computer related data selected from a group including: Web clips, Web services, Web 2.0 semantic components, shared databases.

### SUMMARY OF THE INVENTION

According to the teachings of the present invention there is provided a method, for performing a real time service for monitoring, retrieving and operating on one or more Web Clips in a Web page. The method includes predefining tasks and parameters of the service, triggering a request to start the service, performing the predefined tasks of the service, thereby reading data from the Web clip and thereby creating retrieved data, and analyzing the retrieved data thereby creating a data analysis report.

Predefining the tasks and parameters of the service includes defining the service starting trigger, defining the input parameters of the predefined parameters, defining the output parameters of the predefined parameters, defining one or more tasks to be performed by the service and selecting the first task to be performed by the service.

Preferably, the method further includes the step of validating the request parameters.

Preferably, the method further includes forming a reply message based on the predefined parameters and the analysis of the retrieved data, and sending the reply message to a target as defined in the predefined parameters.

The input parameters include the input communication channel and the input format. The output parameters include the output communication channel and the output format.

Each task of the tasks to be performed by the service includes a task type, a Web page address (URL) and one or more web clips to interact with, task input parameters, task output parameters, analysis and computational logic to be applied the retrieved data, for example, mathematical operations or string parsing, and navigation logic.

The task type can be a read task or an operate task or other tasks, including service internal tasks. The read task includes reading a Web clip of a Web page, thereby obtaining the retrieved data, analyzing the retrieved data thereby creating a data analysis report, and returning the data analysis report. The operate task includes operating on a Web clip of a Web page, reading a Web clip of the Web page, thereby obtaining the retrieved data, analyzing the retrieved data thereby creating a data analysis report and returning the data analysis report.

According to further teachings of the present invention there is provided an interactive Web information system configured to perform method operations for performing a real time service for monitoring, retrieving and operating on one or more Web clips in a Web page. The system includes a request device gateway, an input manager, an output manager, communication means for communicating with the communication device of the user and communication means for communicating with the Web page. The state machine engine includes a raw data interaction manager, a data logic manager; and a navigation logic manager.

The Web information system of the present invention is configure to perform the methods of the present invention, wherein the request device gateway receives and validates an incoming request to start the service and transfers the input parameters to the input manager. The input manager analyzes the input parameters and the predefined parameters of the service. The raw data interaction manager performs the first, predefined task of the service, thereby interacting with the predefined Web page through the communication means for communicating with the Web page, and thereby retrieving data. The retrieved data is analyzed by the data logic manager thereby creating a data analysis report. The navigation logic manager either activates the next task of the service or transfers the data analysis report to the output manager. Optionally, the output manager creates a formatted reply message and sends the reply message through the communication means for communicating with the communication device of the user.

### BRIEF DESCRIPTION OF THE DRAWINGS

The present invention will become fully understood from the detailed description given herein below and the accompanying drawings, which are given by way of illustrations and examples only and thus not limitative of the present invention, and wherein:

FIG. 1 is a schematic block diagram illustration of the tasks and parameters defined by the setup procedure of a service, according to embodiments of the present invention;

FIG. 2 is a schematic flow diagram of defining a task by the setup procedure of a service, according to embodiments of the present invention;

FIG. 3 is a schematic block diagram illustration of system for performing a service for retrieving information from a Web page and/or operating one or more Web clips of a Web page, according to embodiments of the present invention;

FIG. 4 is a schematic flow diagram of an example method for retrieving information from a Web page and/or operating one or more Web clips of a Web page, according to embodiments of the present invention;

FIG. 5 schematically illustrates an example of a service session performed by an interactive Web information server, according to embodiments of the present invention, having an SMS defined as the input communication channel, using a mobile phone;

FIG. 6 schematically illustrates an example of a service session performed by an interactive Web information server, according to embodiments of the present invention, having electronic mail defined as the input communication channel, using a computer;

FIG. 7 schematically illustrates an example of a service session performed by an interactive Web information server, according to embodiments of the present invention, having line phone defined as the input communication channel, using a line phone.

FIG. 8 schematically illustrates an example service for retrieving information from Web pages, performed by an interactive Web information server, according to embodiments of the present invention;

FIG. 9 schematically illustrates an example service that interacts with Web pages, performed by an interactive Web information server, according to embodiments of the present invention, wherein the server activates a selected button in a Web page; and

FIG. 10 illustrates an example of setting up an “American Idol Voting” service according to the pre definition procedure shown in FIG. 1;

### DESCRIPTION OF EMBODIMENTS OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The methods and examples provided herein are illustrative only and not intended to be limiting.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

By way of introduction, the principal intentions of the present invention include providing a system and methods for creating a service for real time interaction with one or more Web pages, including retrieving information from a Web page and/or operating one or more Web clips of a Web page, as predefined for the service for utilizing the method of the present invention.

A service is predefined by defining the input parameters of the service, the output parameters of the service and one or more tasks to be performed by the server performing the service, wherein each tasks is designed to interact with a predefined Web page.

When a user sends a request to execute the service, the input module of the server performing the service analyzes the request parameters and the predefined parameters of the requested service and activates the service first task with the predefined input parameters. The task interacts with a predefined Web page thereby retrieving a data from the Web page. The retrieved data is analyzed yielding a decision to either to use the data analysis report to conclude the service and optionally return a reply message to the user, or to use the data analysis report as input to the next task. If the next task is executed, the task interacts with a predefined Web page and retrieves new data from that Web page. Again, the retrieved data is analyzed yielding a decision to either to use the data analysis report to conclude the service and optionally return a reply message to the user, or to use the data analysis report as input to the next task, and so on and so forth.

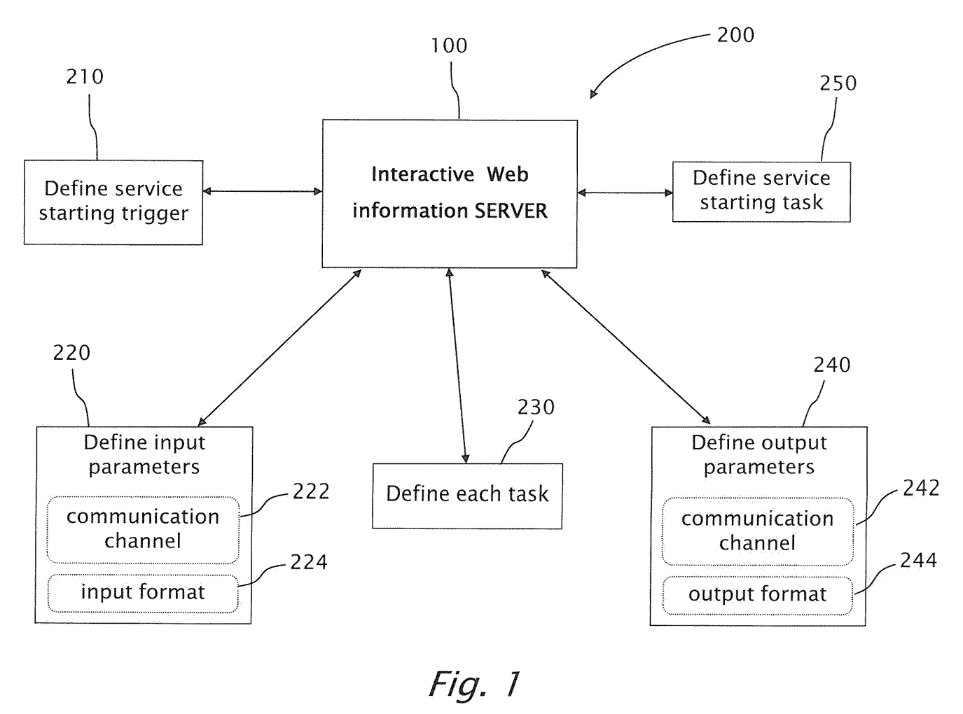

Reference is now made to the drawings. FIG. 1 is a schematic block diagram illustrating the tasks and parameters defined at setup procedure 200 of a service, according to embodiments of the present invention. Setup procedure 200 includes the following steps:
Step 210: Define service starting trigger.
The service operator of interactive Web information server 100 selects the method that will start a service session run. The trigger can be an SMS message, a phone call from a pre selected CID number, a pre set tune, a pre set time and time interval for repeated service sessions, or any other service triggering method.
Step 220: Define input parameters.

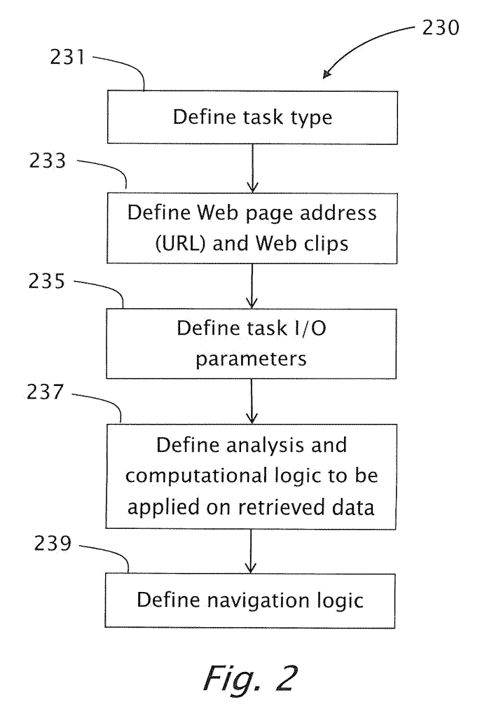

The service operator of interactive Web information server 100 further selects input communication channel 222. For example, SMS for cellular phones (SMS can be also used for other devices), electronic mail (Email) for computers, dial up call (IVR) for line phones or cellular phones, or any other communication capable device. The service operator of interactive Web information server 100 further selects the input format 224 of the data of a start service request.
Step 230: Define each task.
The service operator of interactive Web information server 100 defines the tasks that service may need to run to obtain the objectives of the service. Reference is also made to FIG. 2, which is a schematic flow diagram of defining a task by setup procedure 230 of a service, according to embodiments of the present invention.
Step 231: Define the task type.
There are two basic types of task, but the present invention is not limited to the two task types described and may include other type of tasks including internal, system tasks.
The first type of task is a read task. A read task performs the following steps of:
   a) reading a data segment from a Web page, thereby obtaining retrieved data;
   b) analyzing the retrieved data; and
   c) returning a result based on the analysis of the retrieved data.
The second type of task is an operate task. An operate task performs the following the steps of:
   a) operating on one or more Web clips of a Web page;
   b) reading a Web clip of the Web page, thereby obtaining a retrieved data;
   c) analyzing the retrieved data; and
   d) returning a result based on the analysis of the retrieved data.
Step 233: Define Web page address (URL) and Web clips.
Define the URL of the Web page and one or more web clips to interact with which the task interacts. In variation of the present invention, the task URL is dynamic built and/or calculated by the task run prior to the currently defined task.
Step 235: Define task I/O parameters.
Define input and output formats and parameters of the task. Each task has input data that guides the task interaction with the Web page. Each task returns output data that is either used as input data to the next task or is used to conclude the service and optionally return a reply message to the user.
Step 237: Define analysis and computational logic to be applied on retrieved data.
The service operator defines the analysis logic for analyzing the retrieved data.
Step 239: Define navigation logic.
The service operator defines the navigation logic to either proceed with another task, which is selected based on the analysis of the retrieved data, or to conclude the service and optionally return a reply message to the user.
Step 240: Define output parameters.
The service operator of interactive Web information server 100 further selects output communication channel 242. Optionally, a reply message will be sent to the user through communication channel 242. For example, SMS for cellular phones (SMS can be also used for other devices), Email for computers, dial up call for line phones (it should be noted that this option is available as an output channel only if the service was declared to use IVR as an input) or any other communication capable device. The service operator of interactive Web information server 100 further selects the output format 244 of the reply message.
Step 250: Define service starting task.
The service operator of interactive Web information server 100 defines the first task to be performed when a session of the service is initiated.

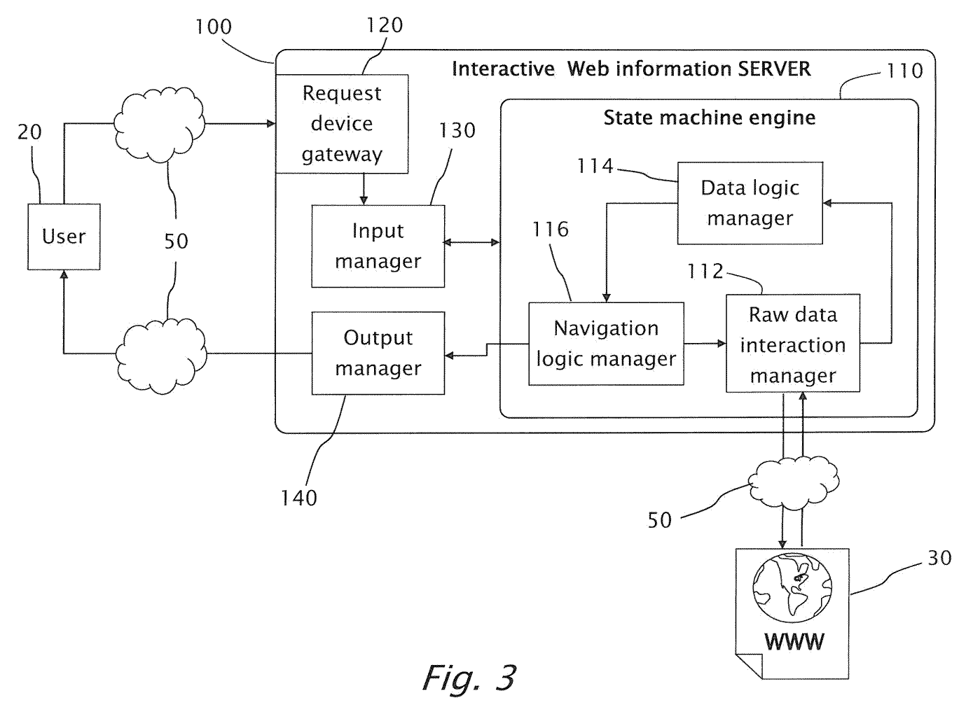

Reference is now made to FIG. 3, which is a schematic block diagram illustration of a system, tangibly embodied by interactive Web information server 100, for performing a service for retrieving information from a Web page and/or operating one or more Web clips of a Web page, according to embodiments of the present invention.

Interactive Web information server 100 includes request device gateway 120, input manager 130, output manager 140 and state machine engine 110. State machine engine 110 includes raw data interaction manager 112, data logic manager 114 and navigation logic manager 116.

Request device gateway 120 receives and validates an incoming request form user 20 to start performing a service and transfers the input parameters to input manager 130. Input manager 130 analyzes the input parameters and the predefined parameters of the service as defined, for example, in procedure 200. Raw data interaction manager 112 performs the first task of the service, thereby interacting with the predefined Web page through the communication means for communicating with the Web page on Web 30 via network 50, and thereby retrieves data.

The retrieved data is analyzed by data logic manager 114 thereby creating a data analysis report. Navigation logic manager 116 either activates the next task of the service based on a predefined set of rules or transfers the data analysis report to output manager 140. Optionally, output manager 140 creates a formatted reply message and sends the reply message through the communication means for communicating with the communication device of user 20.

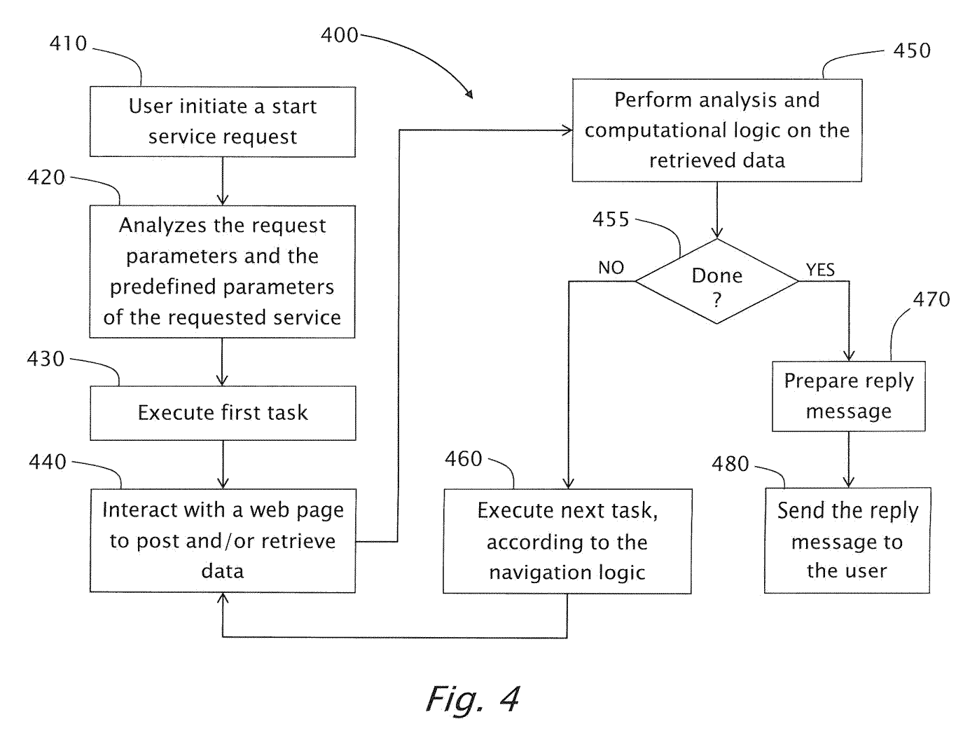

Reference is also now made to FIG. 4, which is a schematic flow diagram of an example method 400 for retrieving information from a Web page and/or operating one or more Web clips of a Web page, according to embodiments of the present invention. Setup procedure 400 includes the following steps:
Step 410: User 20 initiate a start service request.
User 20 sends a start service request to interactive Web information server 100. Request device gateway 120 receives and validates the incoming request and transfers the input parameters of the request to input manager 130.
Step 420: Analyzes the predefined parameters of the requested service.
Input manager 130 analyzes the predefined parameters of the service, including parameters provided by user 20 in the request to start the service.
Step 430: Execute first task.
The service first task, as defined in the predefined set of rules, is executed.
Step 440: Interact with a web page to post and/or retrieve data.
Raw data interaction manager 112 performs currently selected task of the service, thereby interacting with the predefined Web page through the communication means for communicating with the Web page on Web 30 via network 50, and thereby retrieves a data.
Step 450: Perform analysis and computational logic on the retrieved data.
The retrieved data is analyzed by data logic manager 114 thereby creating a data analysis report.
Step 455: Test the data analysis report.
Navigation logic manager 116 tests the data analysis report to determine either to activate the next task of the service or to transfer the data analysis report to output manager 140.
Step 460: Execute next task, according to the navigation logic.
If navigation logic manager 116 decides to activate the next task of the service navigation logic manager 116 selects the next task and returns to step 440.
Step 470: Prepare reply message.
If navigation logic manager 116 decides to conclude the service, navigation logic manager 116 transfers the data analysis report to output manager 140. Typically, a reply message will be sent to user 20 or to another predefined client, else the service is terminated. Output manager 140 prepares the reply according to the predefined output format and parameters.
Step 480: Send the reply message to user 20.
Output manager 140 sends the reply message to user 20.

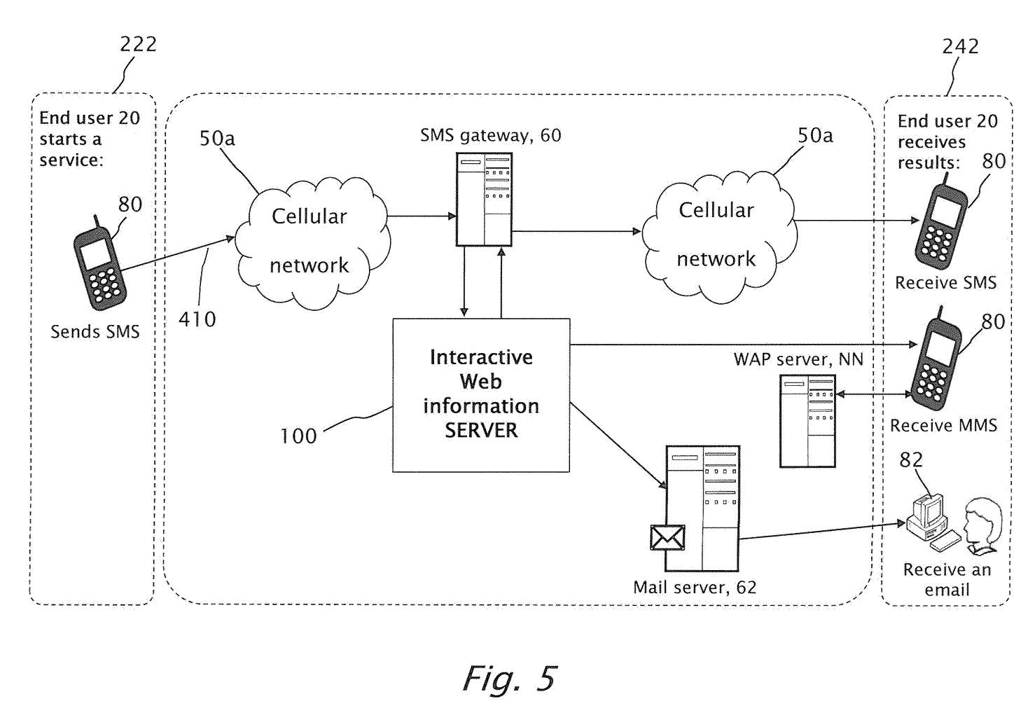

Reference is now made to FIG. 5, which schematically illustrates an example of a service session performed by interactive Web information server 100, according to embodiments of the present invention, having an SMS defined as the input communication channel 222, using mobile phone device 80.

A user 20 starts a service session by sending (410) an SMS via cellular network 50a to an SMS gateway 60 and then to interactive Web information server 100. If, for example, the predefined communication channel is established between server 100 and cellular phone 80, the derived output message is sent as an SMS/MMS message via cellular network 50a to cellular phone 80 of user 20. If, for example, the predefined output device is computer 82, the derived output message is sent as an Email via mail server 62 to computer 82 of user 20.

It should be noted that cellular phone 80 can be replaced by any device capable of sending and/or receiving SMS/MMS messages.

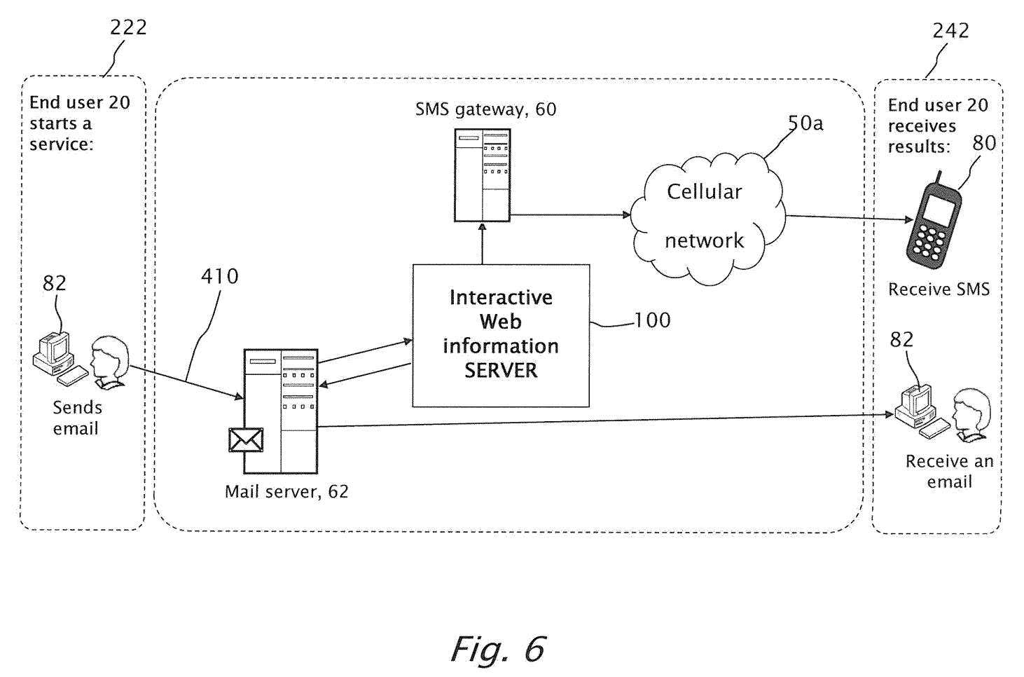

Reference is now made to FIG. 6, which schematically illustrates an example of a service session performed by interactive Web information server 100, according to embodiments of the present invention, having an email defined as the input communication channel 222, using computer 82.

A user 20 starts a service session by sending (410) an Email via mail server 62 to interactive Web information server 100. If, for example, the predefined output device is cellular phone 80, the derived output message is sent as an SMS/MMS message via cellular network 50a to cellular phone 80 of user 20. If, for example, the predefined output device is computer 82, the derived output message is sent as an Email via mail server 62 to computer 82 of user 20.

It should be noted the computer 82 can be replaced by any device capable of sending and/or receiving Email messages.

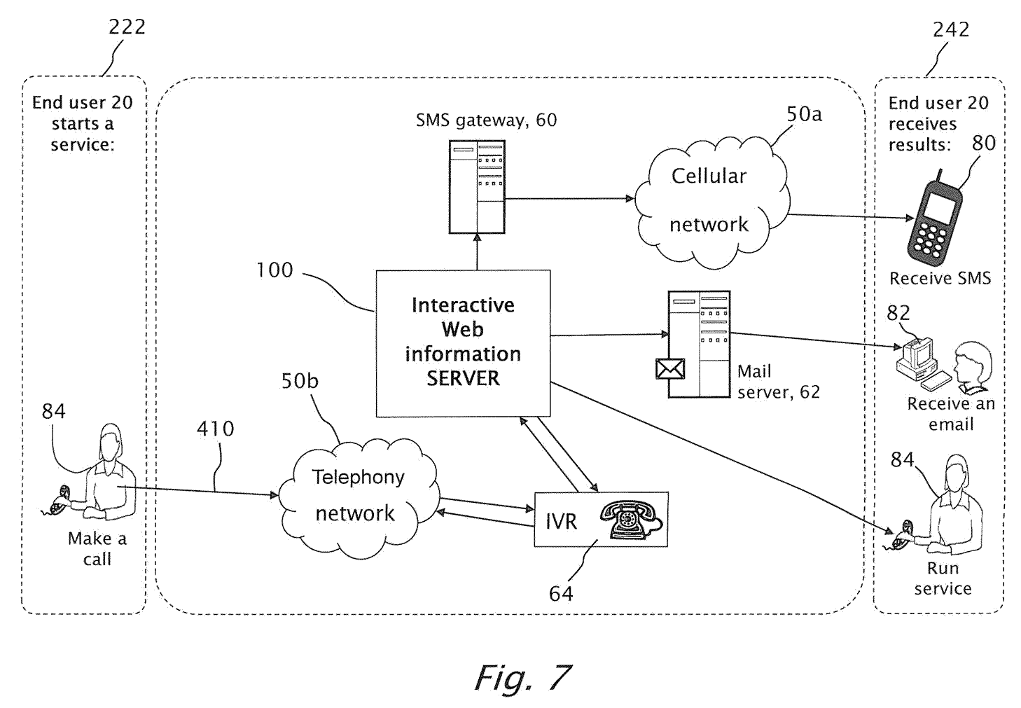

Reference is now made to FIG. 7, which schematically illustrates an example of a service session performed by interactive Web information server 100, according to embodiments of the present invention, having an IVR defined as the input communication channel 222, using line phone 84.

A user 20 starts a service session by making (410) a phone call via telephony network 50b to interactive voice response (IVR) 64 that retrieves the desired user 20 inputs and then forwards the retrieved input to interactive Web information server 100. If, for example, the predefined output device is cellular phone 80, the derived output message is sent as an SMS/MMS message via cellular network 50a to cellular phone 80 of user 20. If, for example, the predefined output device is computer 82, the derived output message is sent as an Email via mail server 62 to computer 82 of user 20. If, for example, the selected output device is a line phone 84 that uses IVR, the derived output message is sent as a voice message to line phone 84 of user 20 (it should be noted that a cellular phone can also initiate an IVR session).

It should be noted that a phone line 84 can be replaced by any device capable of creating an IVR session.

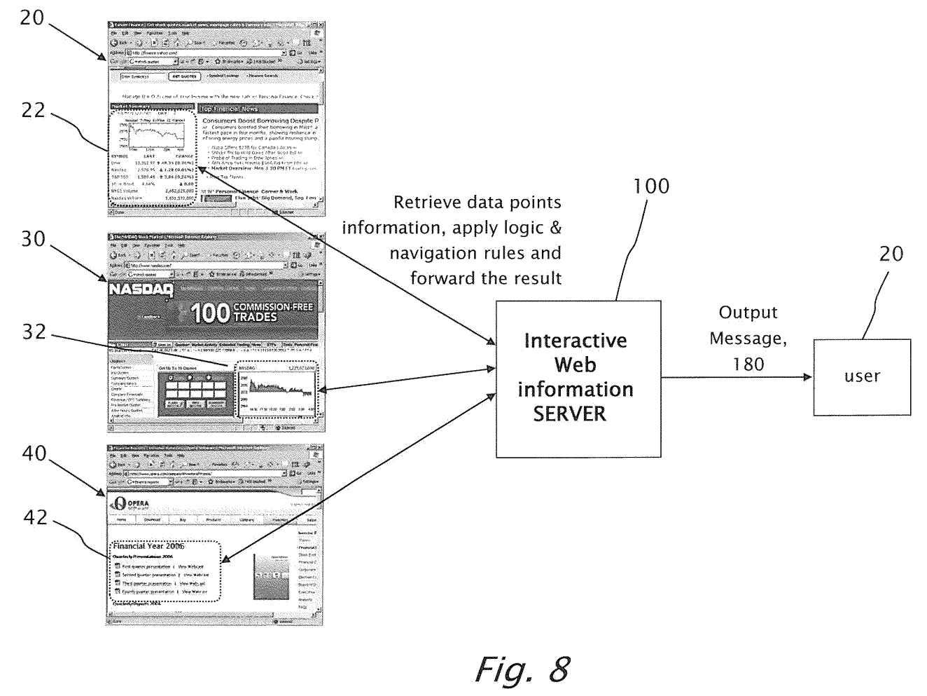

Reference is now made to FIG. 8, which schematically illustrates an example service for retrieving information from Web pages, performed by interactive Web information server 100, according to embodiments of the present invention. In this example, Web clip 22 was defined in Web page 20, Web clip 32 was defined in Web page 30 and Web clip 42 was defined in Web page 40. Server 100 retrieves the data from predefined Web clips 22, 32 and 42, applies predefined logic on the retrieved data, thereby creating a data analysis report. Server 100 then applies navigation rules on the analysis result and when the service is concluded, forwards the analysis result as an output message 180 to the selected output device of user 20.

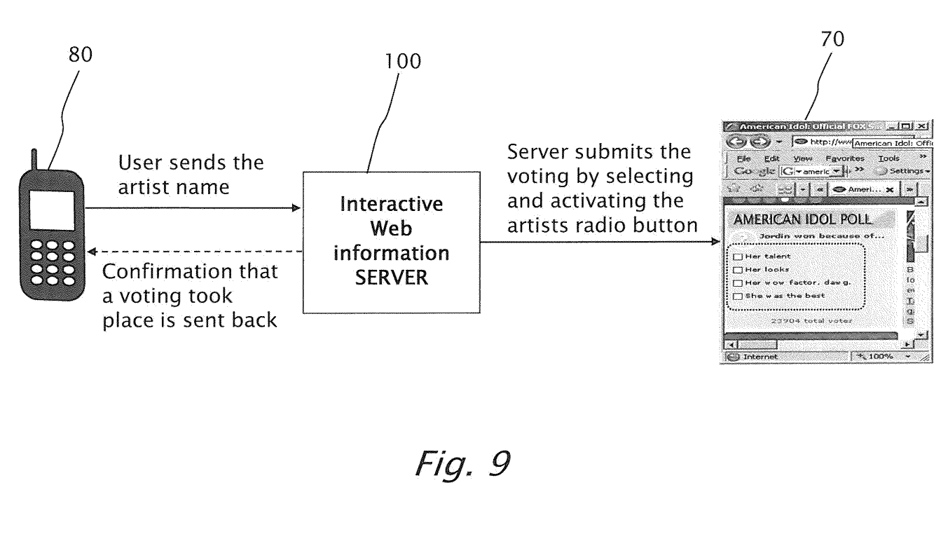

Reference is also made to FIG. 9, which schematically illustrates an example service that interacts with Web pages, performed by an interactive Web information server, according to embodiments of the present invention. In this example, interactive Web information server 100 operates the selected Web page 70 and sends back a confirmation notification to mobile device 80 of user 20. In this application a user sends his/her voting selection, via as SMS message to target Web page 70 of the

American Idol contest. The SMS message is sent to server 100, which analyzes the message sent by user 20 and activated the appropriate artist radio button in Web page 70. A confirmation message that a voting took place is sent back to user 20.

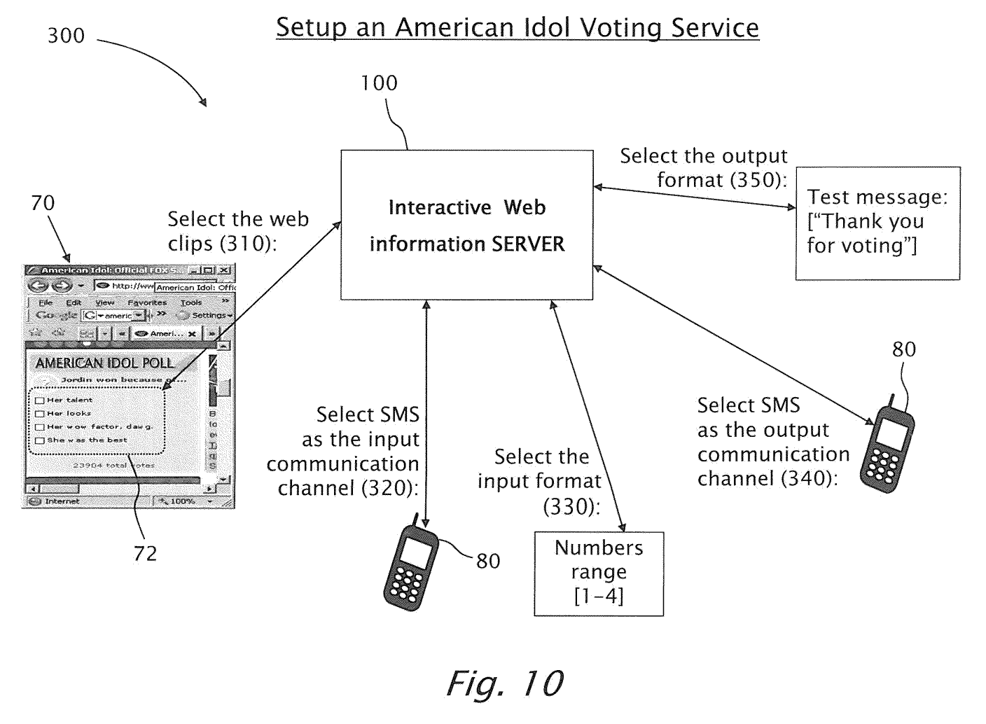

The American Idol contest is illustrated in more details in FIG. 10, which illustrates example setup procedure 300 of an “American Idol Voting”, according to the pre definition procedure 200. In this example, the service operator of interactive Web information server 100 selects (step 310) Web clip 72 of the American Idol Voting Web page 70. The service operator further selects a communication channel to be established between server 100 and mobile phone 80 as the device to be used to initiate a service session of server 100, and SMS as the input communication channel (step 320). The service operator further selects (step 330) SMS as the format of the input message to be the digits 1, 2, 3 and 4. The service operator also selects a communication channel is established between server 100 and mobile phone 80 as the device to receive output message 180 and further selects (step 340) SMS as the output communication channel. In step 350, the service operator of server 100 defines the format of the output message 180 to be: “Thank you for voting”.

In a voting process, the user of mobile phone 80 sends an SMS message containing one digit selected from a group of digits consisting: 1, 2, 3 and 4. The selected digit is processed by server 100 that adds the vote to the appropriate candidate. Server 100 then sends the output message 180 to mobile phone 80.

In another example, server 100 is defined to report inventory status per product. The predefined logic is set to report an item inventory status, if the count of an item is 100 or more. Otherwise, if the count of an item is below 100, order more items to increase the inventory status.

Interactive Web information server 100 of this example is defined as follows:

a) Define an SMS input/output channel 222.

b) Define input format to match the product id (number).

c) Define the Web clips, the logical operation and navigation rules:
i) Web clip #1: The query database field;
   The logical operation: test of result number is less then 100;
   The navigation rules: upon the logical operation, if less the 100 go to Web clip #2, otherwise exit the service by reporting the result to the user via SMS.
ii) Web clip #2: order product field;
   The logical operation: the order operation succeeds;
   The navigation rules: if succeed report the user via SMS, otherwise report that there was an order error.

It should be noted that interactive Web information server 100 of the present invention can be setup without any programming skills.

It should be further noted that the program application of the present invention can be setup without any programming skills.

The invention being thus described in term's of several embodiments and examples, it will be obvious that the same may be varied in many ways. Such variations are not to be regarded as a departure from the spirit and scope of the invention, and all such modifications as would be obvious to one skilled in the art.

What is claimed is:

1. A method for performing a real time service for monitoring, retrieving and operating on one or more Web Clips in a Web page, the method comprising the steps of:
a) predefining tasks and parameters of said service;
b) triggering a request to start said service;
c) performing said predefined tasks of said service thereby reading data from said Web clip and thereby creating retrieved data; and
d) analyzing said retrieved data thereby creating a data analysis report,
wherein said predefining of tasks and parameters of said service comprises the steps of:
i. defining said service starting trigger;
ii. defining the input parameters of said predefined parameters;
iii. defining the output parameters of said predefined parameters;
iv. defining one or more tasks to be performed by said service; and
v. selecting the first task to be performed by said service.

2. The method of claim 1, further comprising the step of:
e) validating said request parameters.

3. The method of claim 1, further comprising the steps of:
f) forming a reply message based on said predefined parameters and said analysis of said retrieved data; and
g) sending said reply message to a target receiving party according to said predefined parameters.

4. The method of claim 1, wherein each of said tasks to be performed by said service comprises:
a) a task type;
b) a Web page address (URL) and one or more Web clips;
c) task input parameters;
d) task output parameters;
e) analysis and computational logic to be applied said retrieved data; and
f) navigation logic.

5. The method of claim 1, wherein said input parameters comprise:
a) the input communication channel; and
b) the input format.

6. The method of claim 1, wherein said output parameters comprise:
a) the output communication channel; and
b) the output format.

7. The method of claim 4, wherein said task type is a read task; wherein said read task comprises the steps of:
a) reading a Web clip of a Web page, thereby obtaining said retrieved data;
b) analyzing said retrieved data thereby creating a data analysis report; and
c) returning said data analysis report.

8. The method of claim 4, wherein said task type is an operate task; wherein said operate task comprises the steps of:
a) operating on a Web clip of a Web page;
b) reading a Web clip of said Web page, thereby obtaining said retrieved data;
c) analyzing said retrieved data thereby creating a data analysis report; and
d) returning said data analysis report.

9. An interactive Web information system configured to perform method operations for performing a real time service for monitoring, retrieving and operating on one or more Web clips in a Web page, the system comprising:
a) a request device gateway;
b) an input manager;
c) an output manager;
d) a state machine engine comprising:
i. a raw data interaction manager;
ii. a data logic manager; and
iii. a navigation logic manager;
e) communication means for communicating with the communication device of the user; and
f) communication means for communicating with said Web page,
wherein said services has predefined tasks and parameters;
wherein said request device gateway receives and validates an incoming request to start said service and transfers the input parameters to said input manager;
wherein said input manager analyzes said input parameters and said predefined parameters of said service;
wherein said raw data interaction manager performs the first task of said service, thereby interacting with said Web page through said communication means for communicating with said Web page, and thereby retrieving data;
wherein said retrieved data is analyzed by said data logic manager thereby creating a data analysis report;
wherein said navigation logic manager either activates the next task of said service or transfers said data analysis report to said output manager; and
wherein optionally, said output manager creates a formatted reply message and sends said reply message through said communication means for communicating with said communication device of said user.
